(19) United States
(12) Patent Application Publication
(10) Pub. No.: US 2004/0030579 A1
(43) Pub. Date: Feb. 12, 2004

(54) Method, system and computer program product for providing medical information

(76) Inventors: Maria Gil, East Greenwich, RI (US); Janice Gil, West Warwick, RI (US)

Correspondence Address: CANTOR COLBURN LLP, 55 Griffin Road South, Bloomfield, CT, 06002, US

(21) Appl. No.: 10/348,590

(22) Filed: Jan. 21, 2003

Related U.S. Application Data
(60) Provisional application No. 60/350,753, filed on Jan. 21, 2002.

(51) Int. Cl. G06F 17/60

(52) U.S. Cl. 705/2

(57) ABSTRACT

A method for providing medical information comprising receiving medical data about a patient and storing the medical data. The method further comprises receiving a consent form associated with the patient, where the patient has consented to the release of the medical data to a medical employee in response to the occurrence of a medical situation involving the patient. The consent form is stored. A notification is received from the medical employee that the medical situation has occurred. A request from the medical employee for access to the medical data is also received. In response to the notification and responsive to the request a subset of the medical data is retrieved. The subset of medical data is transmitted to the medical employee.

### CROSS REFERENCE TO RELATED APPLICATIONS

This application is based upon, and claims the benefit of, U.S. Provisional Patent Application No. 60/350,753 filed on Jan. 21, 2002, which is herein incorporated by reference in its entirety.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF INVENTION

The present invention relates to a method for providing medical information. More specifically, the invention is directed to an application program and database for storing and accessing medical information.

When a medical emergency occurs, time can be wasted when basic medical information about the victim is not available to the medical caregiver. This can be due to the patient being unconscious or to the patient being too upset to remember. The family members of the patient, if they are available, may not be able to supply medical information such as the name of the patient's physician or the date of the patient's last visit to the physician. In addition, family members may not be aware of the medications being taken by the patient and the reason for each medication. Other information that could be helpful in getting proper medical treatment include: blood type of the patient; the type of medical insurance coverage the patient has and the name of the healthcare provider; whether the patient has a durable power of attorney or a living will for healthcare; and if the patient has any allergies.

In addition, routine medical care for a patient often involves several physicians. In many cases each physician keeps separate medical records containing overlapping and sometimes inconsistent data. A patient may not be receiving the best possible care when each physician treating the patient does not have the full and accurate medical history of the patient.

### SUMMARY OF INVENTION

One aspect of the invention is a method for providing medical information. The method comprises receiving medical data about a patient and storing the medical data. The method further comprises receiving a consent form associated with the patient, where the patient has consented to the release of the medical data to a medical employee in response to the occurrence of a medical situation involving the patient. The consent form is stored. A notification is received from the medical employee that the medical situation has occurred. A request from the medical employee for access to the medical data is also received. In response to the notification and responsive to the request a subset of the medical data is retrieved. The subset of medical data is transmitted to the medical employee.

Another aspect of the invention is a system for providing medical information. The system comprises a network and a storage device in communication with the network. The system further comprises a user system in communication with the network and a host system in communication with the network. The host system includes application software to implement a method comprising receiving medical data about a patient via the network and storing the medical data in a database located on the storage device. The method further comprises receiving a consent form associated with the patient via the network, where the patient has consented to the release of the medical data to a medical employee in response to the occurrence of a medical situation involving the patient. The consent form is stored in the database. A notification is received from the medical employee that the medical situation has occurred. A request from the medical employee for access to the medical data is also received. In response to the notification and responsive to the request a subset of the medical data is retrieved. The subset of medical data is transmitted to the medical employee.

A further aspect of the invention is a computer product for providing medical information. The computer program product comprises a storage medium readable by a processing circuit and storing instructions for execution by the processing circuit for performing a method. The method comprises receiving medical data about a patient and storing the medical data. The method further comprises receiving a consent form associated with the patient, where the patient has consented to the release of the medical data to a medical employee in response to the occurrence of a medical situation involving the patient. The consent form is stored. A notification is received from the medical employee that the medical situation has occurred. A request from the medical employee for access to the medical data is also received. In response to the notification and responsive to the request a subset of the medical data is retrieved. The subset of medical data is transmitted to the medical employee.

Further aspects of the invention are disclosed herein. The above discussed and other features and advantages of the invention will be appreciated and understood by those skilled in the art from the following detailed description and drawings.

### BRIEF DESCRIPTION OF DRAWINGS

Referring now to the drawings wherein like elements are numbered alike in the several FIGURES:

FIG. 1 is an exemplary consent for release of information form;

FIG. 2 is an exemplary verification of information form;

FIG. 3 is an exemplary ERC membership card;

FIG. 4 is a block diagram of an exemplary system for providing medical information;

FIG. 5 presents the first part of an exemplary ERC database layout;

FIG. 6 presents the second part of an exemplary ERC database layout;

FIG. 7 is a block diagram of an alternate exemplary system for providing medical information;

FIG. 8 is an exemplary user interface for member and membership information data;

FIG. 9 is an exemplary user interface for contact data;

FIG. 10 is an exemplary user interface for physician data;

FIG. 11 is an exemplary user interface for medication data;

FIG. 12 is an exemplary user interface for pharmacy data;

FIG. 13 is an exemplary user interface for surgery data;

FIG. 14 is an exemplary user interface for x-ray data;

FIG. 15 is an exemplary user interface for allergy data;

FIG. 16 is an exemplary user interface for immunization data;

FIG. 17 is an exemplary user interface for special needs data;

FIG. 18 is an exemplary administrative user interface;

FIG. 19 is an exemplary user interface for medication names and descriptions;

FIG. 20 is an exemplary user interface for adding or editing physician information;

FIG. 21 is an exemplary operator user interface;

FIG. 22 is an exemplary operator user interface for special needs data;

FIG. 23 is an exemplary operator user interface for emergency response call center notes;

FIG. 24 is an exemplary operator user interface for member lookup by member identification;

FIG. 25 is an exemplary operator user interface for member lookup by last name;

FIG. 26 is an exemplary operator user interface for member lookup by city;

FIG. 27 is an exemplary operator user interface for member lookup by phone number;

FIG. 28 is an exemplary member and emergency contact data report;

FIG. 29 is an exemplary member physician data report;

FIG. 30 is an exemplary medications and pharmacy data report;

FIG. 31 is an exemplary surgery, x-ray, allergies, and immunization data report; and

FIG. 32 is an exemplary special needs data report.

### DETAILED DESCRIPTION

The present invention can be used to supply essential medical information about a patient. The medical information may be utilized in an emergency, or for pre-op admissions, or used as background information by the various physicians seen by a particular patient, or for medical care while traveling. The present invention can be utilized to help ensure that a patient receives informed care by putting the patient's personal medical history in an easy to access repository. As long as the caregiver can gain access to the data stored by the present invention, the patient data is available even if the patient is unconscious or too upset to remember vital information.

An embodiment of the present invention allows for medical data such as current medications being taken, allergies, blood type, existing medical conditions, special needs, physician names and telephone numbers, emergency contact names and phone numbers, primary language spoken, previous surgeries, and x-rays, to be stored in a secure database. An embodiment of the present invention, referred to as the emergency response card (ERC) application program and database, can be implemented from a central location or individual facilities can manage their own information on a private network. In addition, an embodiment of the present invention can be utilized to provide comprehensive medical information (ERC comprehensive) or to provide emergency medical information (ERC emergency) or various combinations of both types of medical information.

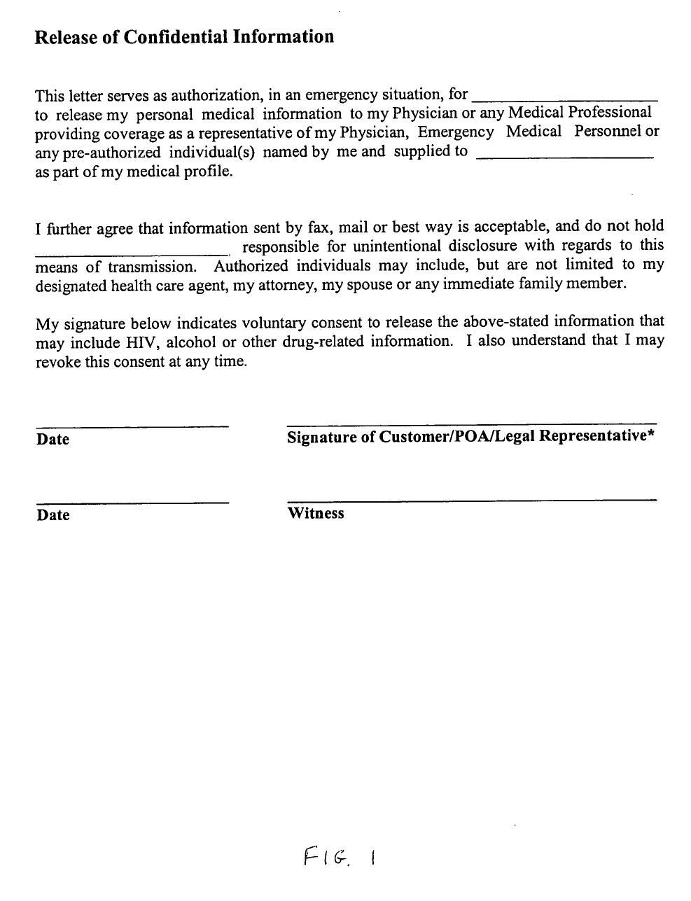

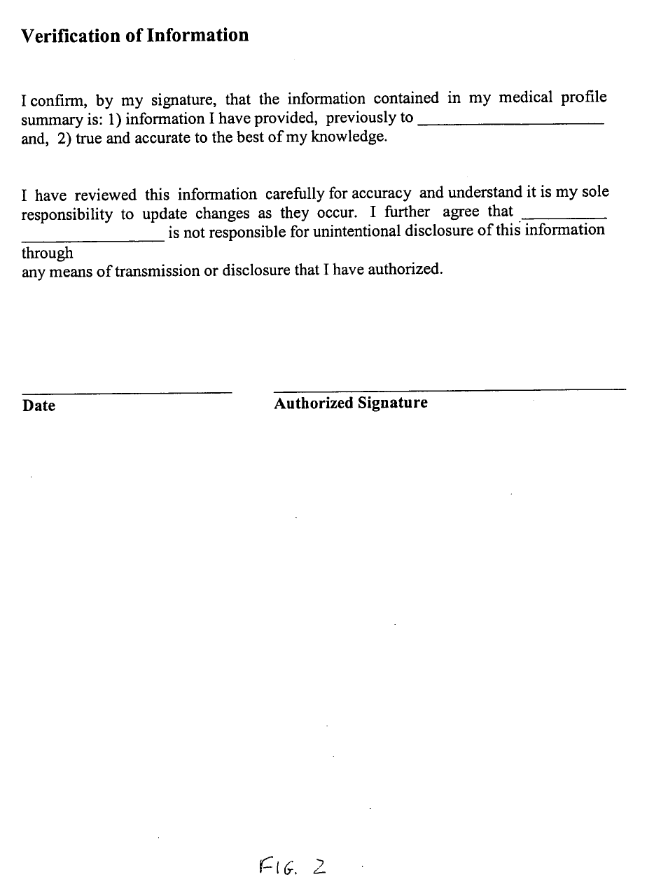

In an emergency, police, fire, rescue and medical personnel can call an emergency response hotline. Police, fire, rescue and medical personnel are also referred to as medical employees when they require access to patient medical data in order to assist in providing patient care in response to a medical situation. Using an embodiment of the present invention, immediate access to medical information can be provided to operators located at the emergency response hotline location. Operators at the emergency response hotline location may retrieve patient medical data and report critical medical details over the telephone to medical employees. The operators may also e-mail or fax a complete record to the hospital or treatment center. Patients that have subscribed to the services provided by utilizing an embodiment of the present invention (i.e., members), may be required to sign release of information and verification of information forms before an account can be activated and medical information released. The requirement to sign consent for release of information and verification of information forms and their content is driven by government regulations (e.g., HIPAA). See FIG. 1 for an exemplary consent, or release of information, form and FIG. 2 for an exemplary verification of information form.

An embodiment of the present invention can be used to generate a report containing member medical information that can be provided to each member. This report can be used when visiting physicians, for pre-op admissions, when traveling for business or pleasure, for daycare (adult and infant) and in any situation that calls for personal medical information in detail. Other data such as insurance co-payments, advance directives and organ donor status could also be included in the report. The report can enhance communication between doctors and patients during both emergency and routine visits. In addition, duplicate medications (generic and name brand) can be easily discovered. Updates to the medical information can be performed on a regular basis (e.g., by mail, by computer, or by telephone).

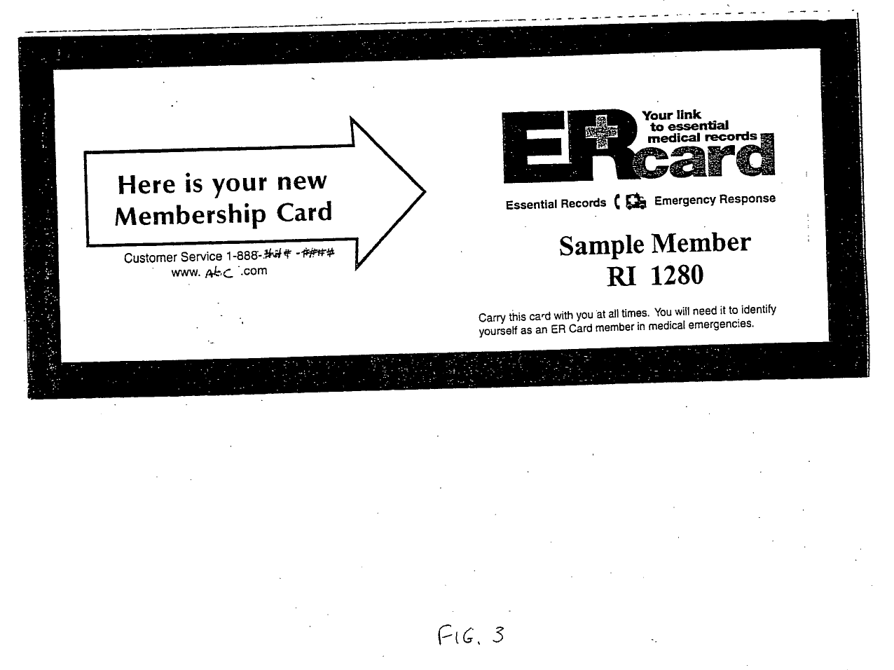

Additional embodiments of the present invention may include, but are not limited to, a magnetic stripe swipe card and a smart pen. An embodiment of the present invention may utilize biometric technology (e.g., voice recognition, face recognition, and fingerprint recognition) in authenticating a member's identity and be utilized to further address confidentiality issues and liability issues with respect to the caregiver, or medical employee. See FIG. 3 for an exemplary ERC membership card, the card in FIG. 3 provides further protection because it does not display the member name, social security or insurance numbers. In another embodiment, medical information for a member may be stored on a disk and translations into the languages spoken in the foreign countries where the member is being treated may be provided.

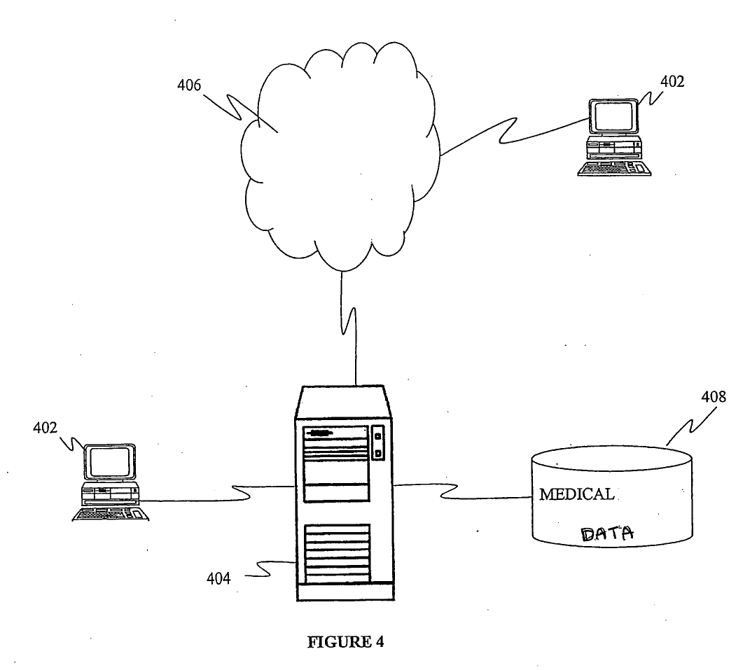

Referring to FIG. 4, a block diagram of an exemplary system for ERC is generally shown. The system in FIG. 4 may be used to support an ERC implementation that includes a single, centralized ERC application program and database accessible by operators and administrators at an emergency response hotline location. The system includes one or more user systems 402 through which users at one or more locations (e.g., hospital, emergency response hotline location) contact the host system 404. In an exemplary embodiment, the host system 404 executes the ERC application program. The user systems 402 may be coupled to the host system 404 via a network 406. Each user system 402 may be implemented using a general-purpose computer executing a computer program for carrying out the processes described herein. The user systems 402 may be personal computers or host attached terminals. If the user systems 402 are personal computers, the processing described herein may be shared by a user system 402 and the host system 404 (e.g., by providing an applet to the user system 402).

The network 406 may be any type of known network including, but not limited to, a wide area network (WAN), a local area network (LAN), a global network (e.g. Internet), a virtual private network (VPN), and an intranet. A user system 402 may be coupled to the host system through multiple networks (e.g., intranet and Internet) so that not all user systems 402 are coupled to the host system 404 through the same network. One or more of the user systems 402 and the host system 404 may be connected to the network 406 in a wireless fashion. In one embodiment, the network is the Internet and a user system 402 executes a user interface application (e.g. a web browser) to contact the host system 404 through the network 406 while another user system 402 is directly connected to the host system 404. The network 406 may be implemented using a wireless network or any kind of physical network implementation known in the art.

Storage device 408 may be implemented using a variety of devices for storing electronic information. It is understood that storage device 408 may be implemented using memory contained in host system 404 or it may be a separate physical device. Storage device 408 is logically addressable as a consolidated data source across a distributed environment that includes a network 406. Information stored in storage device 408 may be retrieved and manipulated via host system 404. Storage device 408 includes the ERC database of medical data for members. Storage device 408 may also include other kinds of data such as information concerning the updating of ERC data (e.g., a user identifier, date, and time of update). In an exemplary embodiment, the host system 404 operates as a database server and coordinates access to application data including data stored on storage device 408.

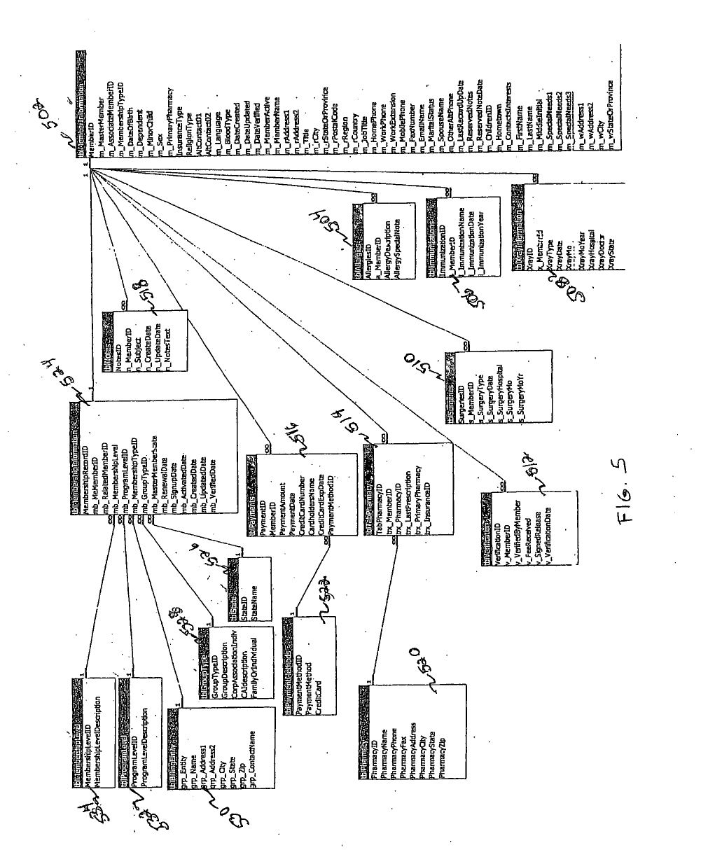

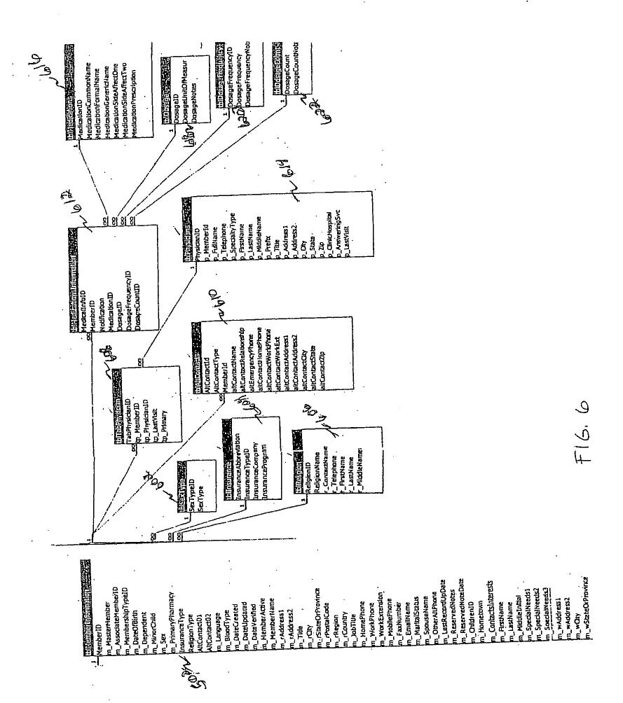

FIGS. 5 and 6 depict an exemplary relational database model layout for the ERC database that contains the patient medical data. In an exemplary embodiment, the relational database is implemented utilizing an Access database product, however, any database product known in the art may be utilized by an embodiment of the present invention. The ERC database may be located on the storage device 408 or accessible through the storage device 408. The tables depicted in FIG. 5 include: Member Information 502; Allergies 504; Immunizations 506; X-ray Information 508; Surgeries 510; Verification 512; Tab Pharmacy 514, including pharmacies the patient has used to fill prescriptions; Payments 516; Notes 518, such as emergency response hotline operator notes; Pharmacy 520; Payment Methods 522; Membership Information 524; State 526; Group Type 528; Billing Entity 530; Program Level 532; and Membership Level 534. The tables in FIG. 6 include: Member Information 502; Sex Type 602; Insurance 604; Religion 606; Tab Physician 608, which includes physicians that have seen the patient; Alt Contacts 610; Medications Information 612; Physicians 614; Medications 616; Dosage 618; Dosage Frequency 620; and Dosage Count 622. In alternate exemplary embodiments, tables and data elements can be added or removed from the layout depending on specific implementation requirements. For example, a database layout for an ERC emergency implementation may contain a subset of these tables such as: Member Information 502, Tab Physician 608, Physicians 614, Medications Information 612, Allergies 504, Alt Contacts 610, Immunizations 506, Insurance 604 and Surgeries 510. In addition, the data stored in each of these tables may include a subset of the data included in FIGS. 5 and 6 as well as additional data fields if required by a specific implementation for performing emergency care.

The host system 404 depicted in FIG. 4 may be implemented using one or more servers operating in response to a computer program stored in a storage medium accessible by the server. The host system 404 may operate as a network server (e.g., a web server) to communicate with the user systems 402. The host system 404 handles sending and receiving information to and from user systems 402 and can perform associated tasks. The host system 404 may also include a firewall to prevent unauthorized access to the host system 404 and enforce any limitations on authorized access. For instance, an administrator may have access the entire system and have authority to modify portions of the system. Access to the system and specific data items in the database may be password protected to protect member privacy. The firewall may be implemented using conventional hardware and/or software as is known in the art.

The host system 404 may also operate as an application server. The host system 404 executes one or more computer programs to perform ERC functions. Processing may be shared by the user system 402 and the host system 404 by providing an application (e.g., java applet) to the user system 402. Alternatively, the user system 402 can include a stand-alone software application for performing a portion of the processing described herein. As previously described, it is understood that separate servers may be used to implement the network server functions and the application server functions. Alternatively, the network server, the firewall, and the application server may be implemented by a single server executing computer programs to perform the requisite functions.

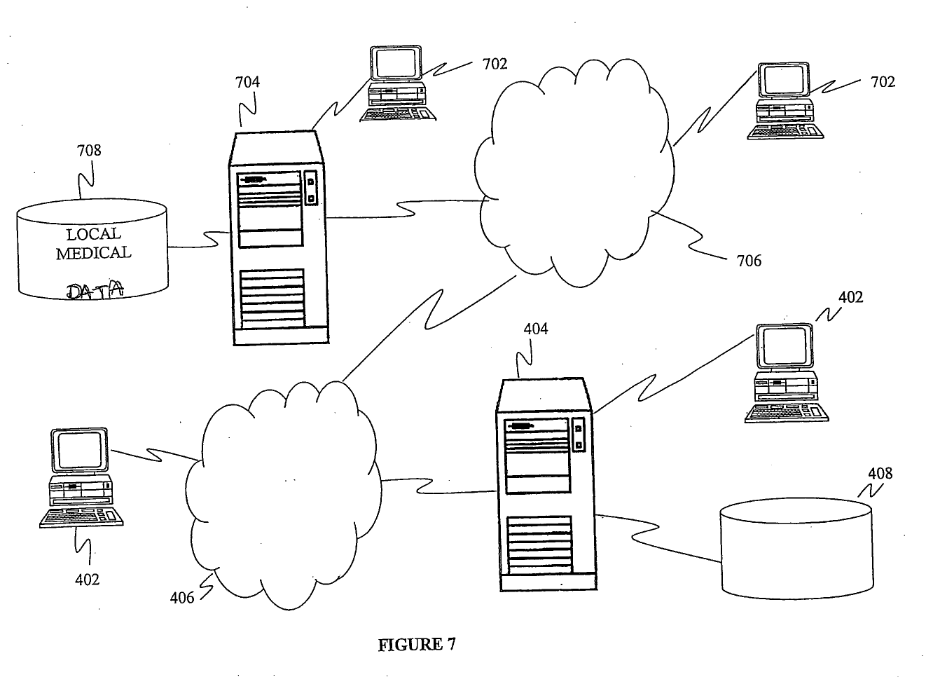

Referring to FIG. 7, a block diagram of an alternative exemplary system for ERC is generally shown that could be used in an ERC implementation that includes multiple ERC application programs and databases. This system may be utilized to support a central call in number for medical data related to medical emergencies as well as a local ERC comprehensive implementation for a medical community (e.g., hospital, HMO). Referring to FIG. 7, the system includes a local host 704 running a local ERC application program, a local ERC database on a local storage device 708, a network 706, and user systems 702. The local ERC system is connected to the ERC system described in FIG. 4 through the networks 706 406. FIG. 7 depicts one local ERC implementation but an embodiment of the present invention could be used to support multiple local ERC implementations.

The network 706, host system 704, storage device 708, and user systems 702 have the same characteristics as those described in reference to the network 406, host system 404, storage device 406, and user systems 402, respectively. Data contained in the ERC database can be shared using any methods known in the art. For example, in one embodiment, the ERC database stored on the central location storage device 408 could be updated in real time or through periodic updates with ERC emergency information from the database stored on the local storage device 706. Alternatively, the ERC database stored on the local storage device 706 could be accessed by the operators using the central user systems 402; or the emergency data for a particular member could be stored in the central database data storage device 408 and the comprehensive data database could be stored in the storage device 706. The exemplary embodiments described in reference to FIGS. 4 and 7 are provided as examples only and many other distributed system implementations are possible utilizing an exemplary embodiment of the present invention.

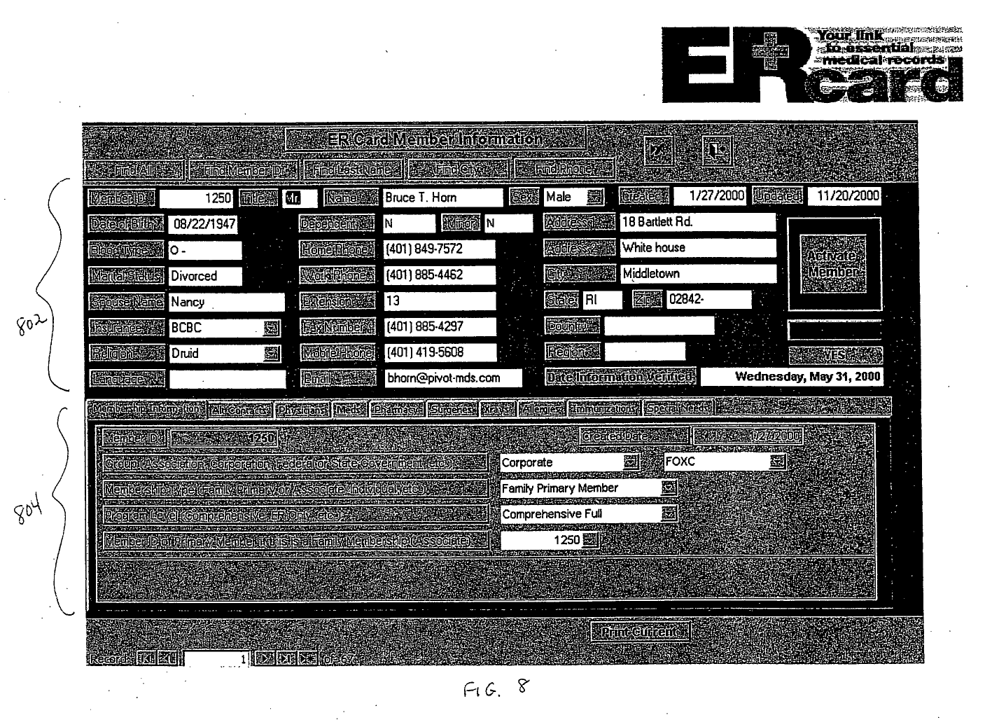

An application program function included in an exemplary embodiment of the present invention and executed by a host system 404 704 includes the ability to enter and access comprehensive medical information for a patient, or member (this is referred to as ERC comprehensive). ERC comprehensive may be used to collect a full personal medical profile as well as emergency response data in the ERC database. The data may include any data fields depicted in FIGS. 5 and 6 such as: member name and birth date; primary physician name and phone numbers; specialists' names and phone numbers; dentist name and phone number; insurance provider name; allergies; emergency contacts; medications; previous surgeries; blood type; chronic medical conditions; pharmacies; membership information; and any other medical information. This data may be entered, updated and viewed by an operator at a user system 402 702 and stored in one or more databases on one or more storage devices 408 708. Depending on what the operator requests, all or a subset of the data medical data stored in the database will be retrieved and displayed. The operator may then deliver this information to the requestor (medical employee or patient) in any manner including facsimile, computer and telephone. FIGS. 8 through 20 include exemplary user interfaces for viewing and updating exemplary ERC comprehensive data.

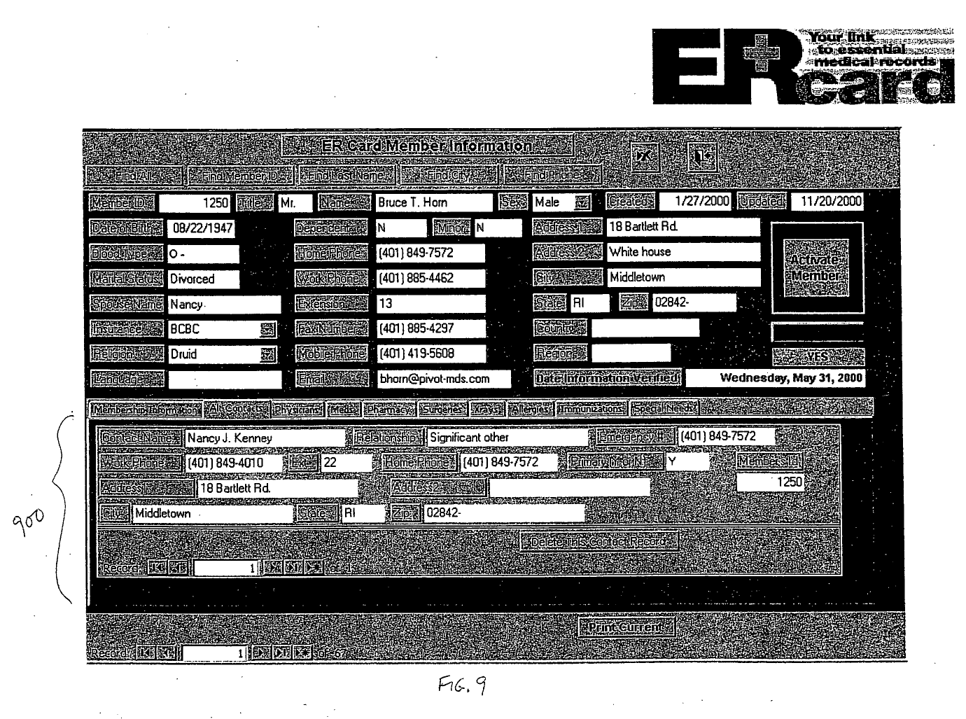

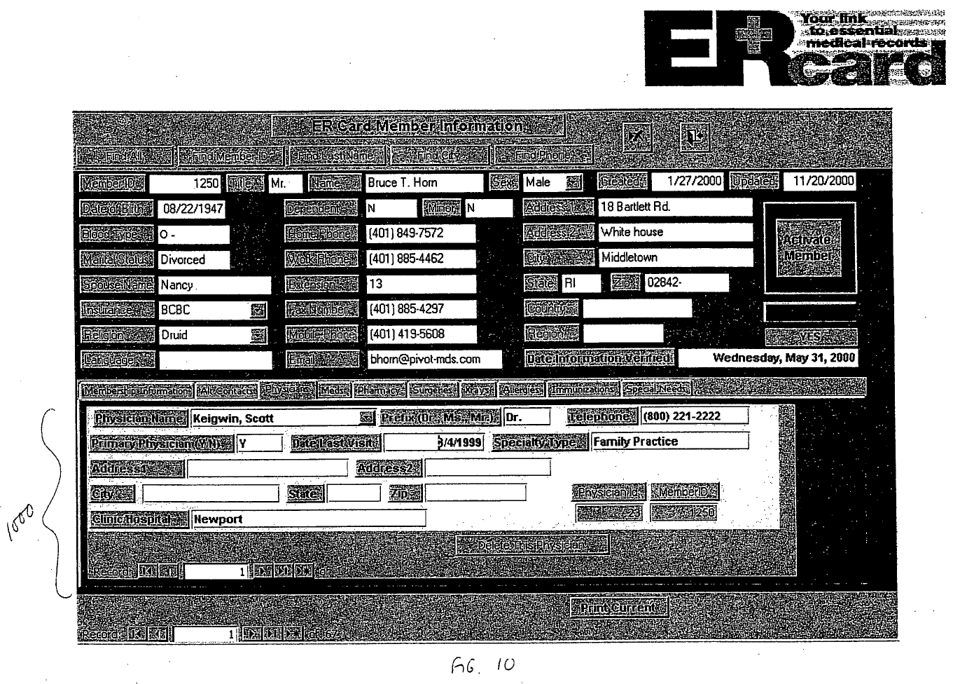

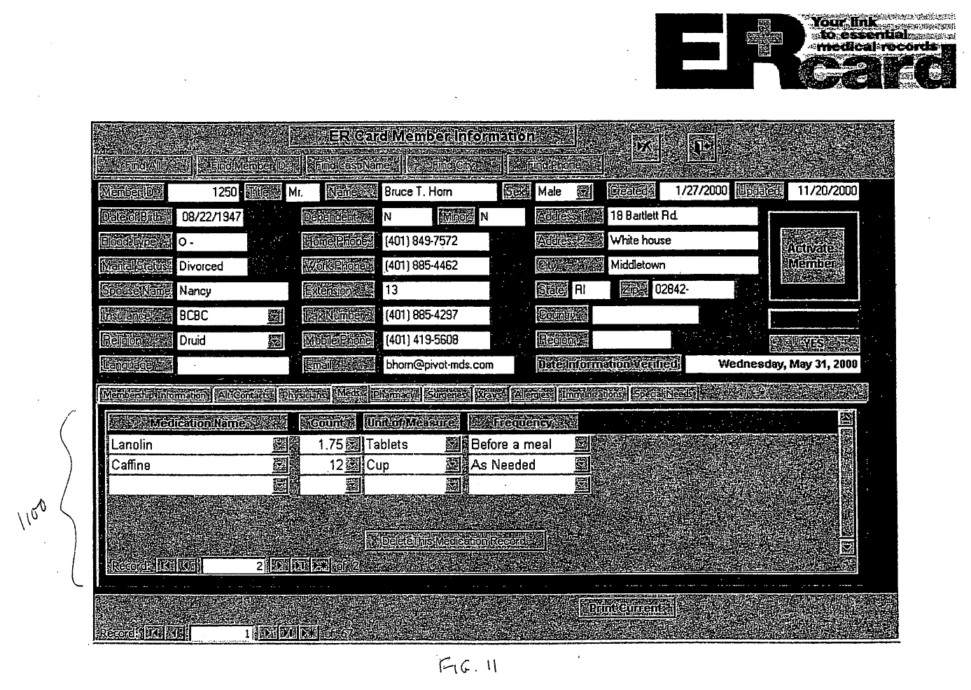

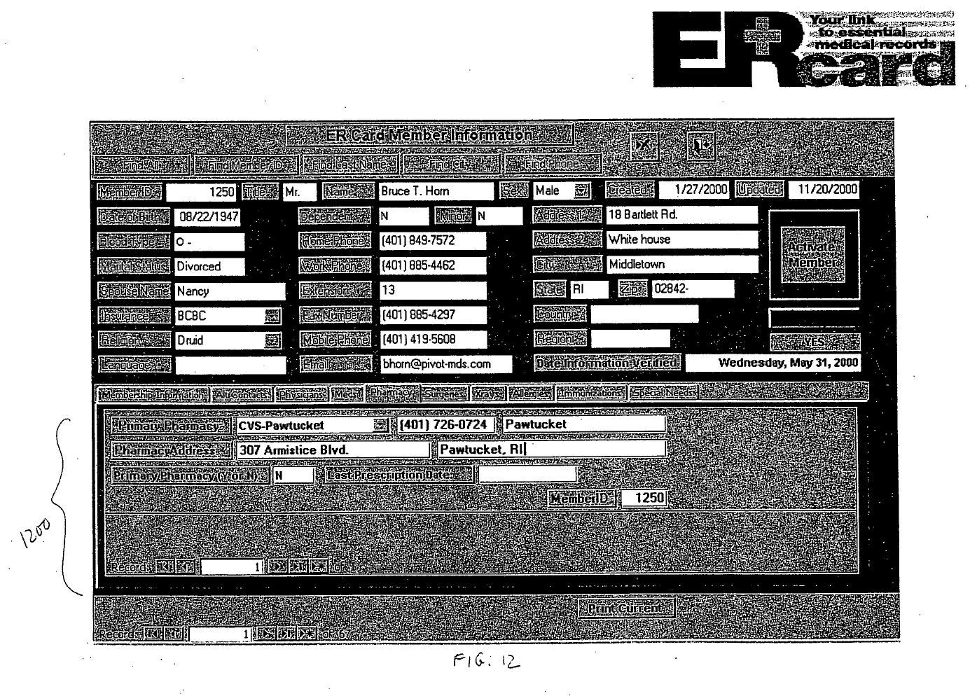

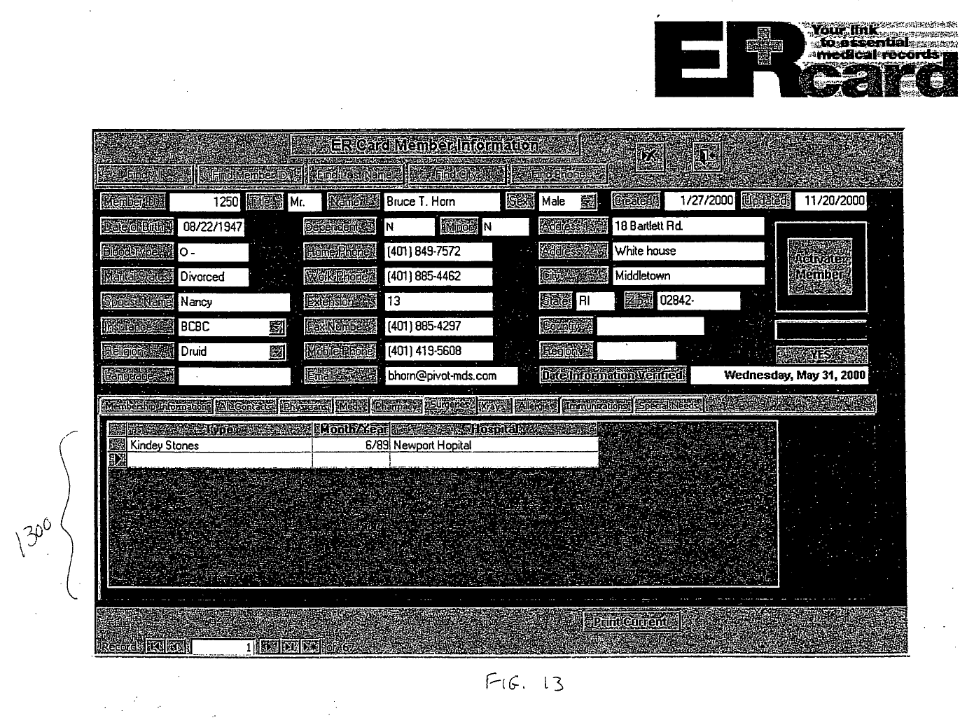

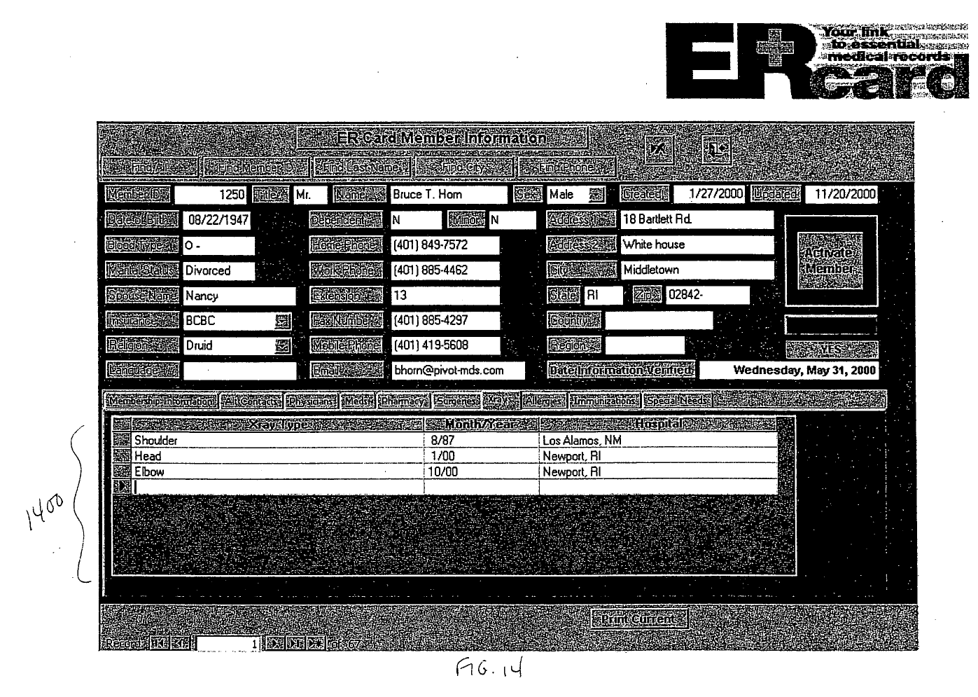

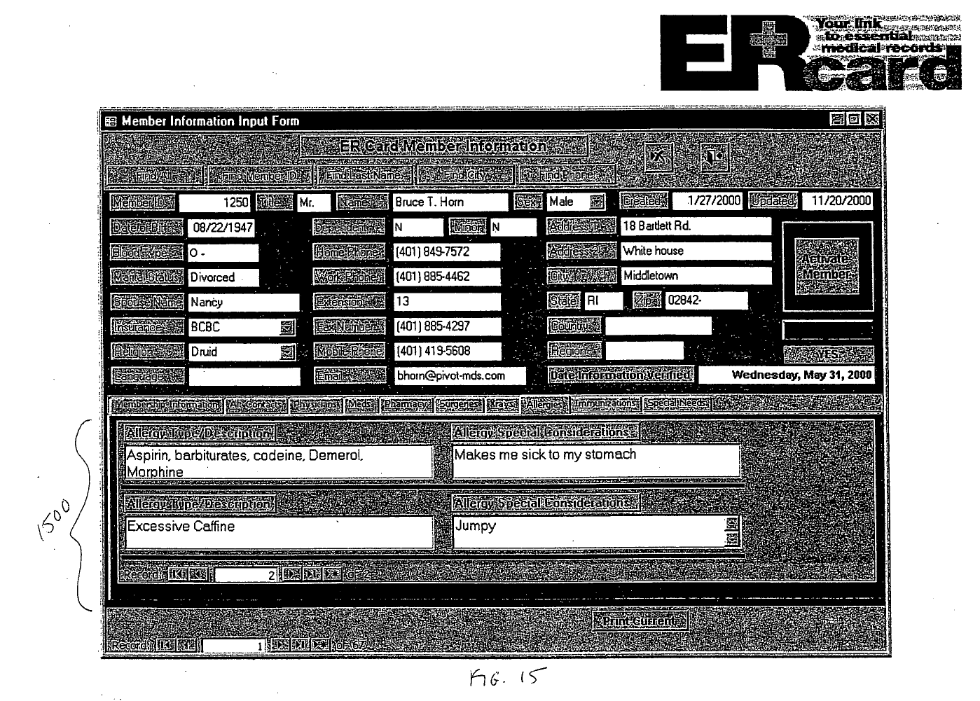

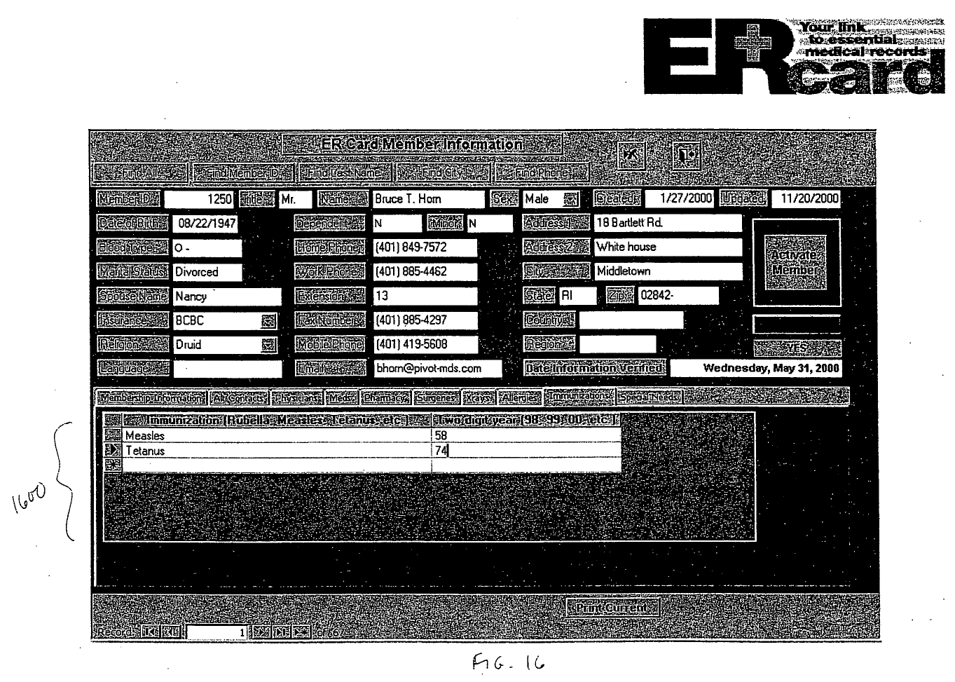

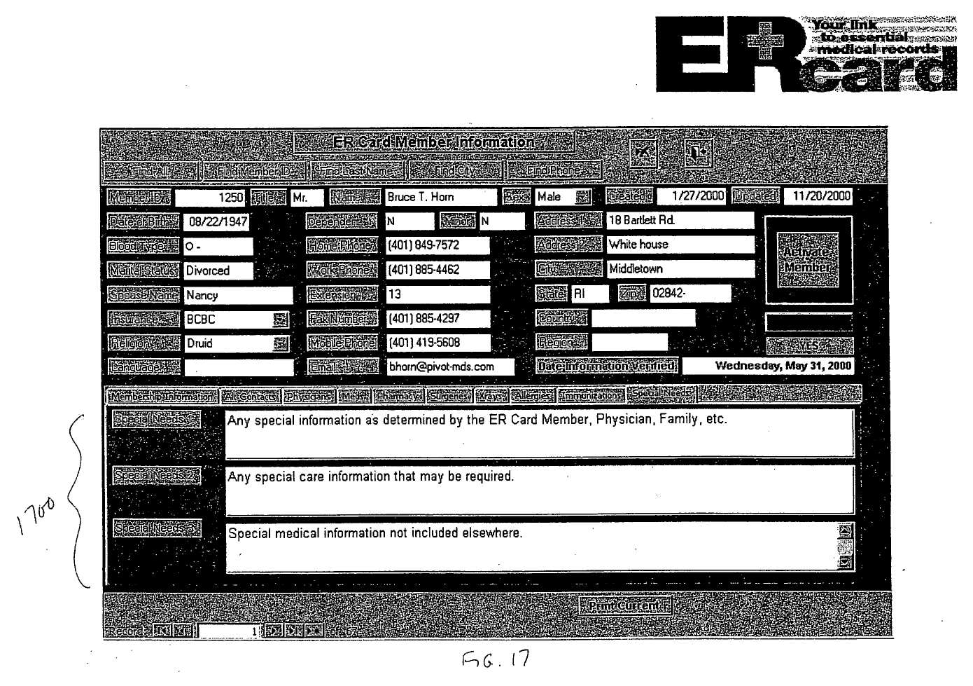

FIG. 8 is an exemplary membership information user interface 804 for viewing and updating membership information data that may be stored in the Membership Information 524, Membership Level 534, Group Type 528 and Program Level 532 tables. Also shown in FIG. 8 is an exemplary member information user interface 802 for viewing and updating member information data that may be stored in the Member Information 502, Verification 512, Insurance 604 and Religion 606 tables. In an exemplary embodiment, the member information user interface 802 is displayed along with any other user interface screens in the ERC application. FIG. 9 is an exemplary contact data user interface 900 for viewing and updating contact data that may be stored in the Alt Contacts 610 table. The “print current” selection provides the ability to print the contact information and the “delete this contact record” selection allows for the user to delete the contact record currently being viewed through the contact user interface 900. FIG. 10 is an exemplary physician information user interface 1000 that may be utilized to view and update physician data that may be stored in the Tab Physician 608 and Physicians 614 tables. FIG. 11 is an exemplary medication information user interface 1100 that may be utilized to view and update medication data that may be stored in the Medications Information 612 table. Similarly, FIG. 12 includes an exemplary pharmacy information user interface 1200; FIG. 13 an exemplary surgery information user interface 1300; FIG. 14 an exemplary x-ray data user interface 1400; FIG. 15 an exemplary allergy data user interface 1500; FIG. 16 an exemplary immunization data user interface 1600; and FIG. 17 an exemplary special needs information user interface 1700. The data for all of these user interface screens may be stored in a database in the various tables described in reference to FIGS. 5 and 6. The specific data values and screen layouts in these figures are for example purposes only and will vary depending on the specific requirements of each implementation.

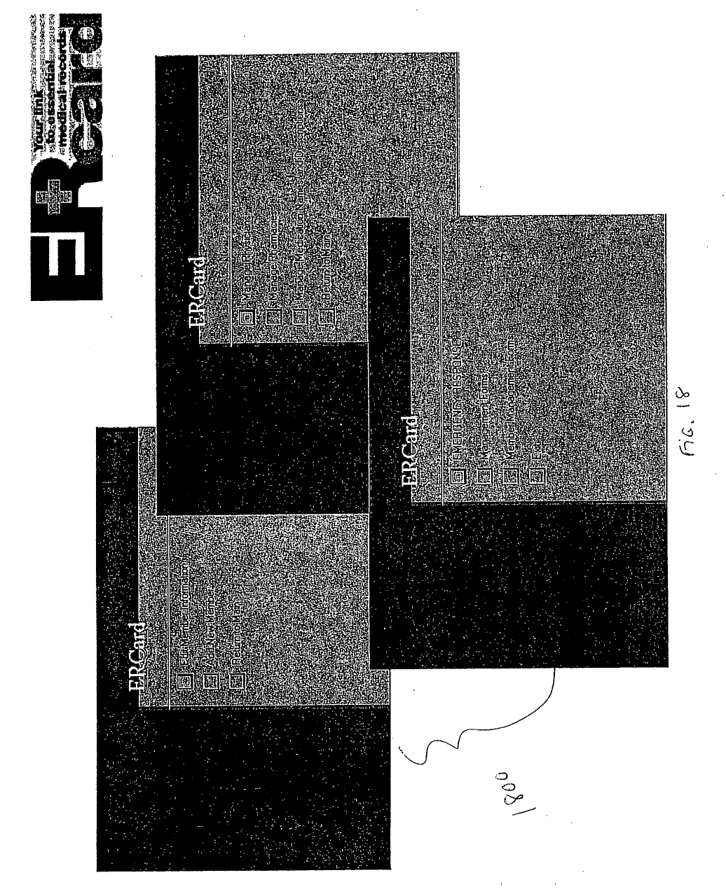

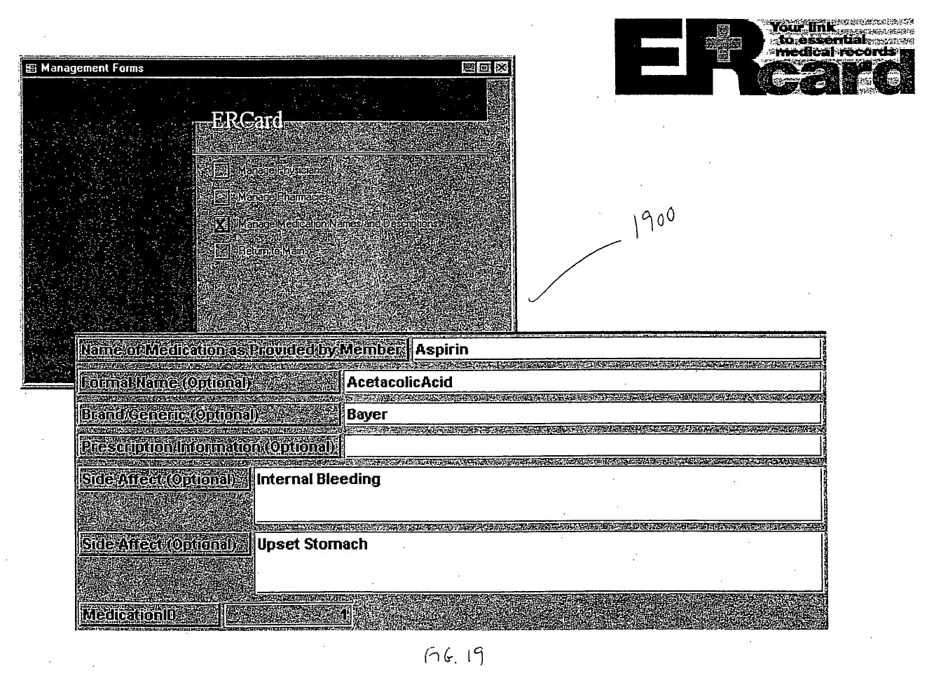

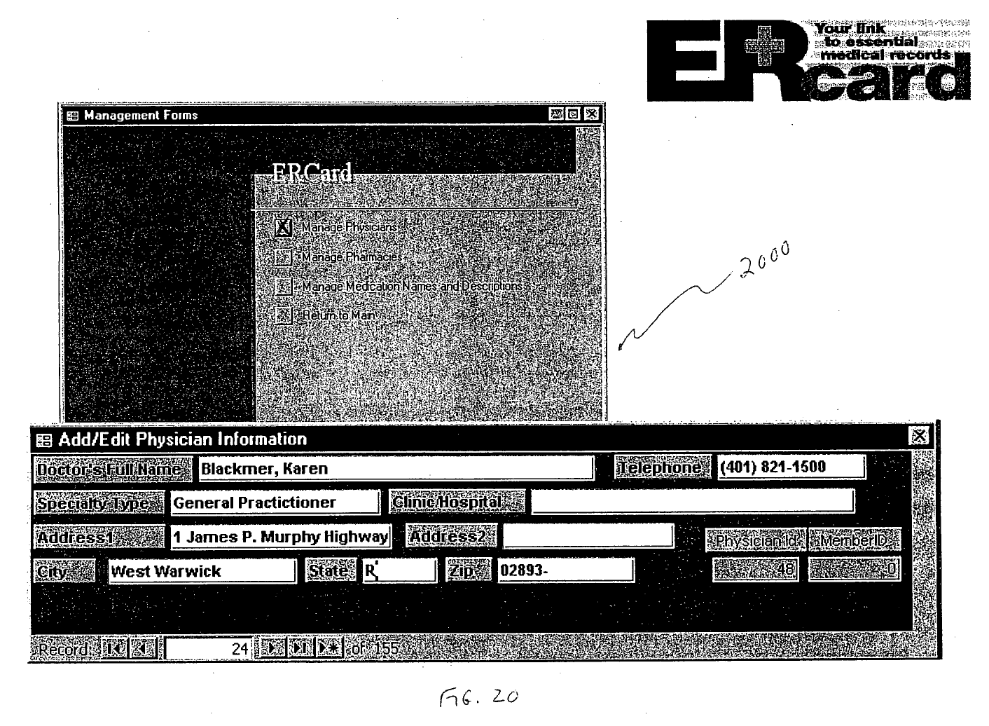

Another application program function included in an exemplary embodiment of the present invention and executed by a host system 404 704 includes the ability to enter and access only emergency response data (this is also referred to as ERC emergency). ERC emergency can be used to collect data that would be helpful in an emergency for storage in the ERC database. In an exemplary embodiment of the present invention, the emergency data includes: member name and birth date; allergies; blood type; primary physician name and phone numbers; emergency contact; and medications. This data may be updated and viewed by an operator at a user system 402 702 and stored in one or more databases on one or more storage devices 408 708. FIG. 18 depicts several exemplary administrative user interface menus 1800 that may be utilized in an ERC emergency implementation. The system administrator, with access to update the ER emergency data, can select to update emergency response data, management forms and member management forms. In addition, the administrator may add a new member and edit member information. Additionally, as shown in the administrative user interface menus 1800, the administrator may update physician, pharmacy, and medication name and description data. FIG. 19 depicts an exemplary manage medication user interface 1900. Data about a medication, such as common name, formal name, brands, prescription information and side affects may be entered in the manage medication user interface 1900 depicted in FIG. 19. FIG. 20 depicts an exemplary manage physician user interface 2000. Data about a physician, such as full name, telephone number, specialty, clinic/hospital and address may be entered in the manage physician user interface 2000 depicted in FIG. 20.

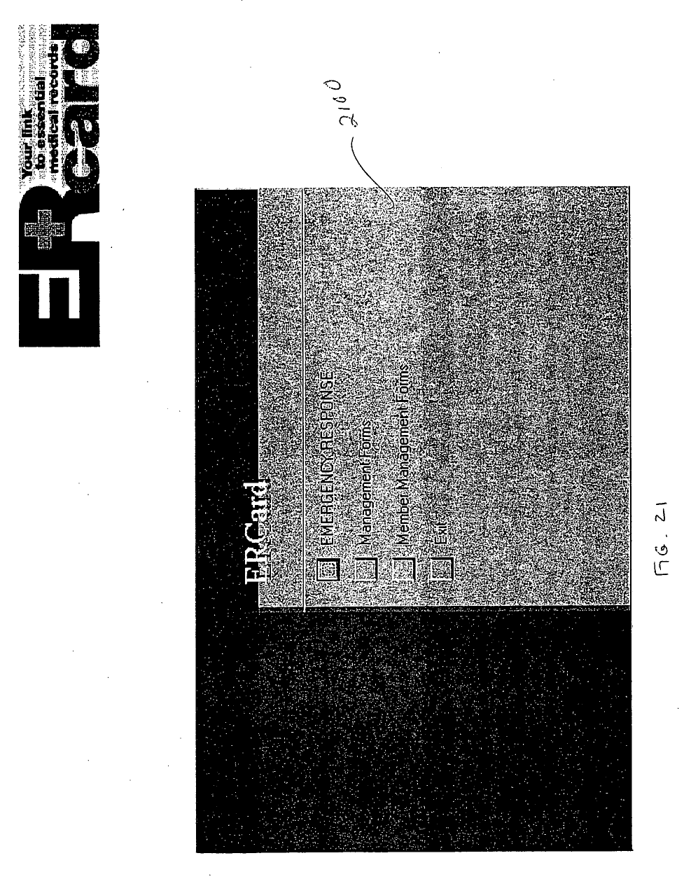

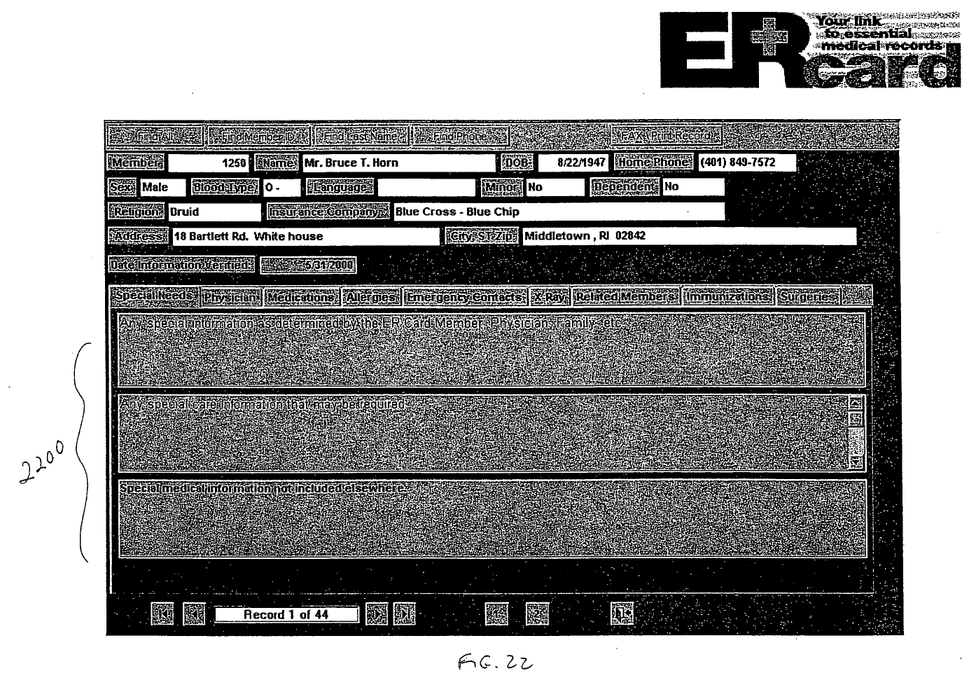

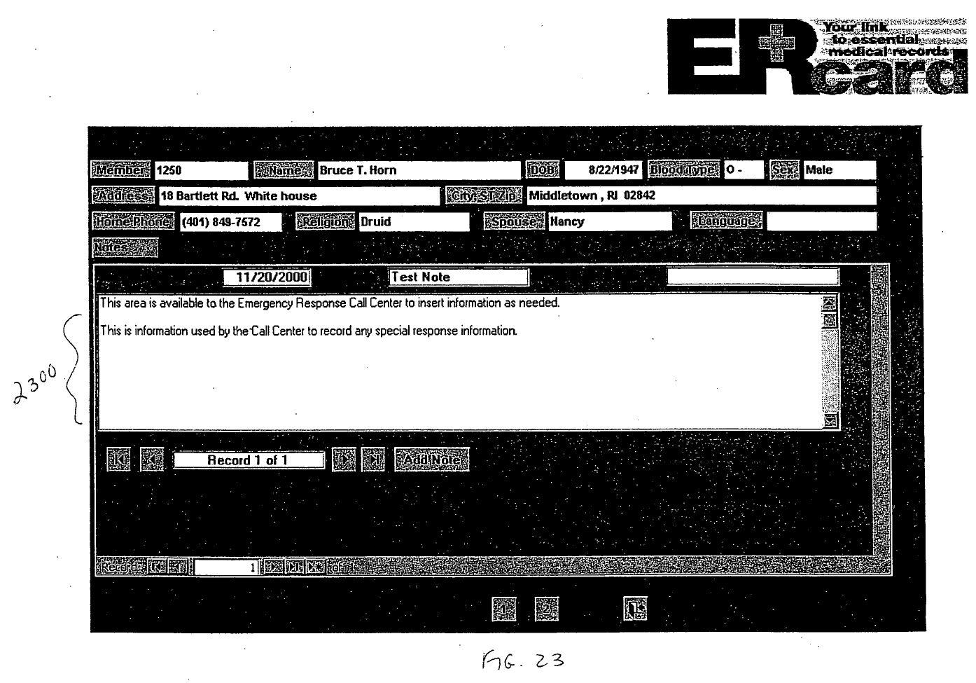

FIGS. 21 through 27 include exemplary user interfaces for accessing ERC emergency data. In addition, the user interfaces in FIGS. 8 through 20, or a subset of these user interfaces, could be used to access the ERC emergency data. The specific data elements in these figures are for example purposes only and will vary depending on the specific requirements of each implementation. FIG. 21 is an exemplary ERC emergency front end screen 2100 that could be presented to an operator at an emergency response hotline location. FIG. 22 includes an exemplary operator user interface 2200 that may be utilized to view the special needs of a patient. FIG. 23 includes an exemplary emergency response call center note user interface 2300 that can be viewed and updated by an operator of the ERC emergency system.

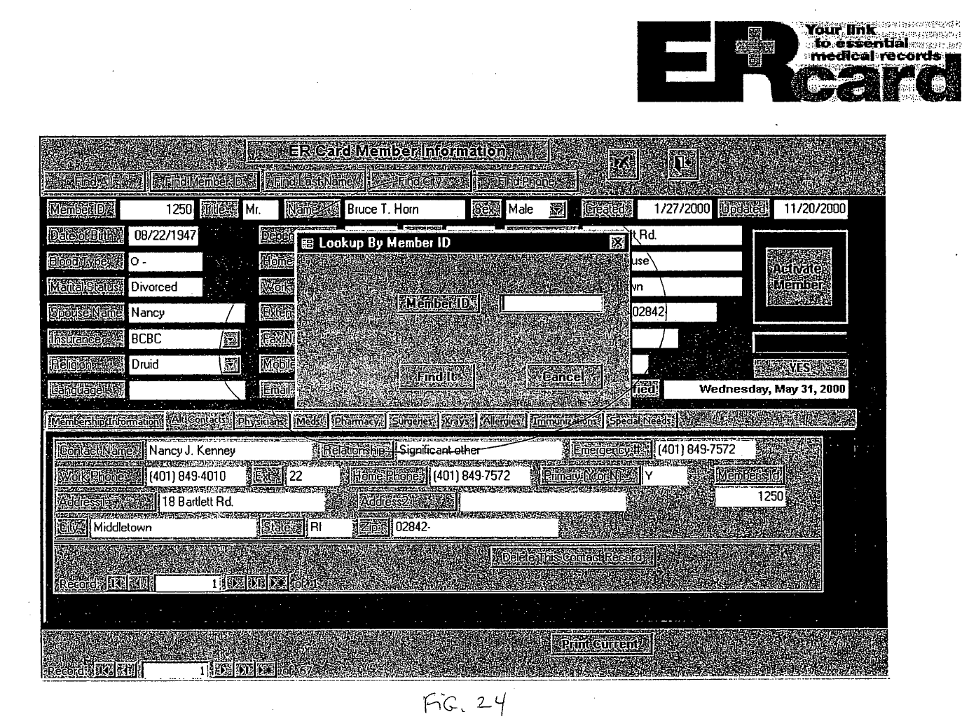

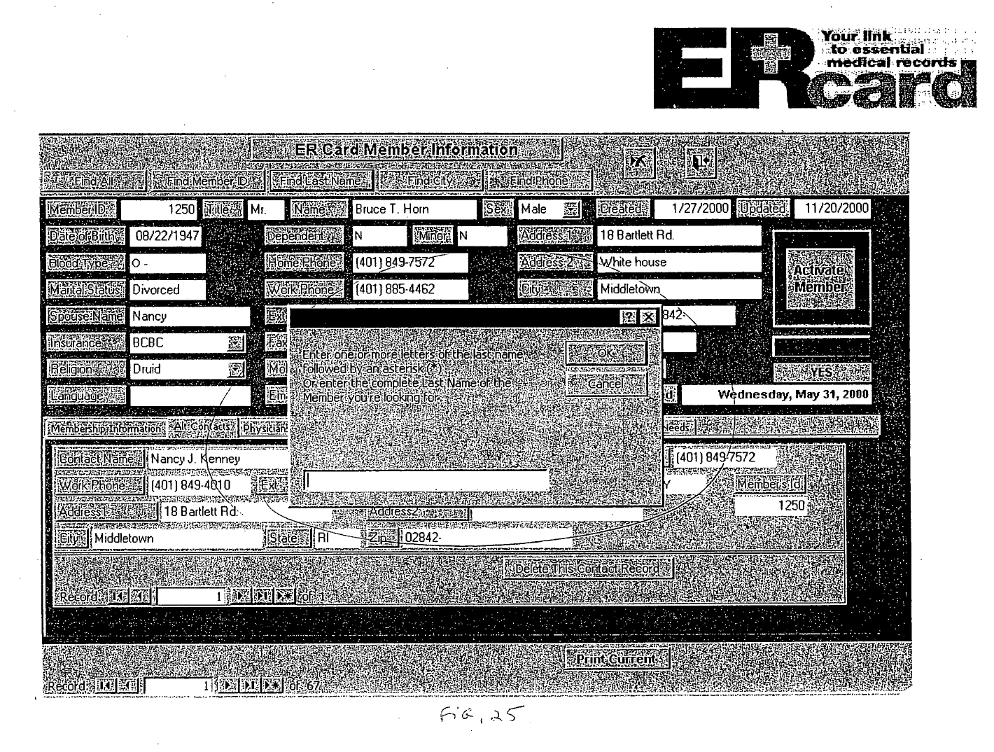

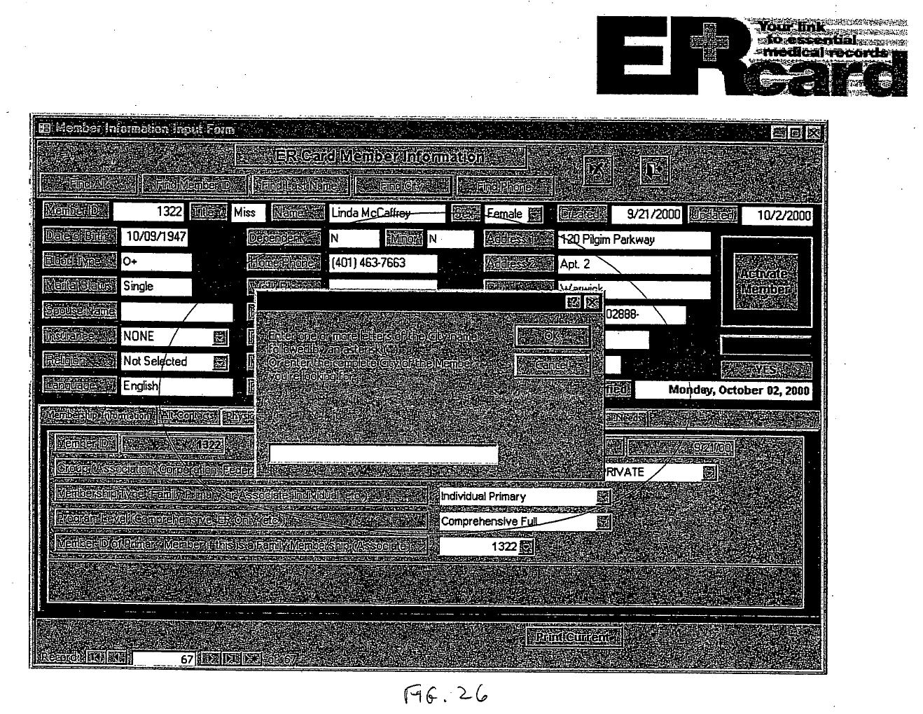

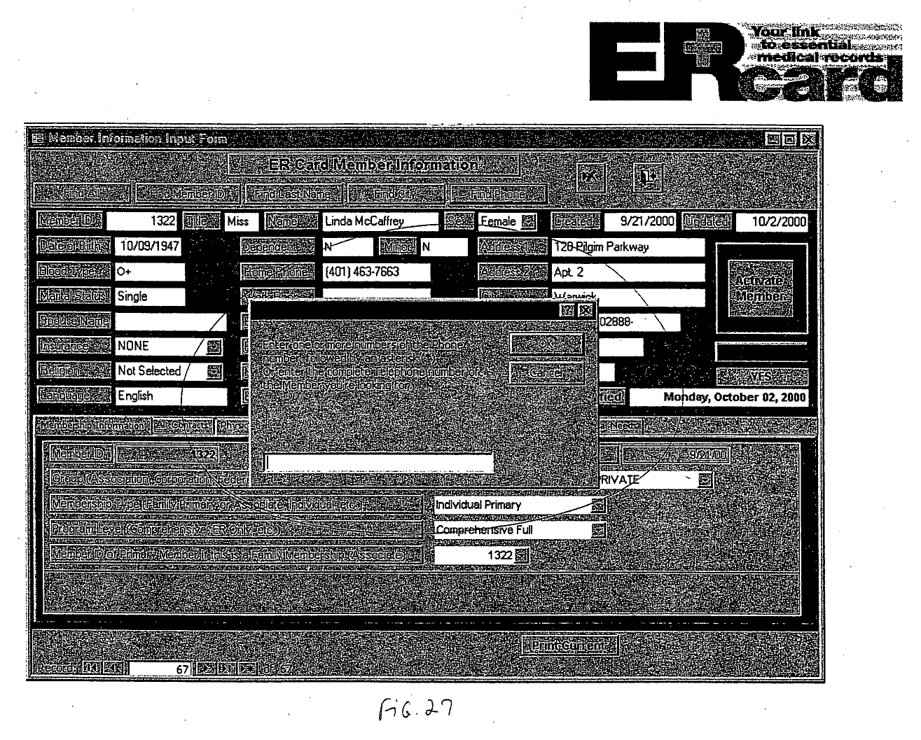

FIGS. 24, 25, 26, and 27 are exemplary user interfaces for looking up member data. These user interfaces may be accessed by an operator, located at an emergency response hotline location for example, who is responding to a data request from an emergency care physician or another authorized medical employee. Member emergency data can be accessed by entering the member identification (FIG. 24), by entering a partial or complete last name (FIG. 25), by entering a partial or complete city name (FIG. 26), or by entering a partial or complete phone number (FIG. 27). These examples are not meant to be limiting and other methods of retrieving member data can be implemented using the present invention. Once the patient, or member, is located a screen containing patient data, such as the one depicted in FIG. 8, may be displayed.

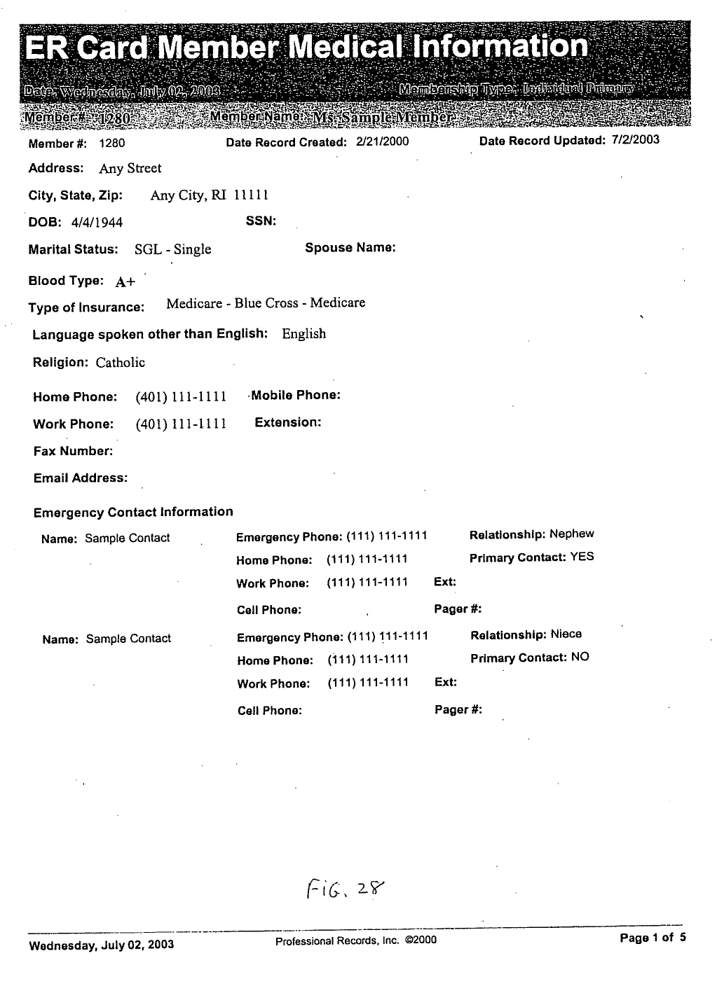

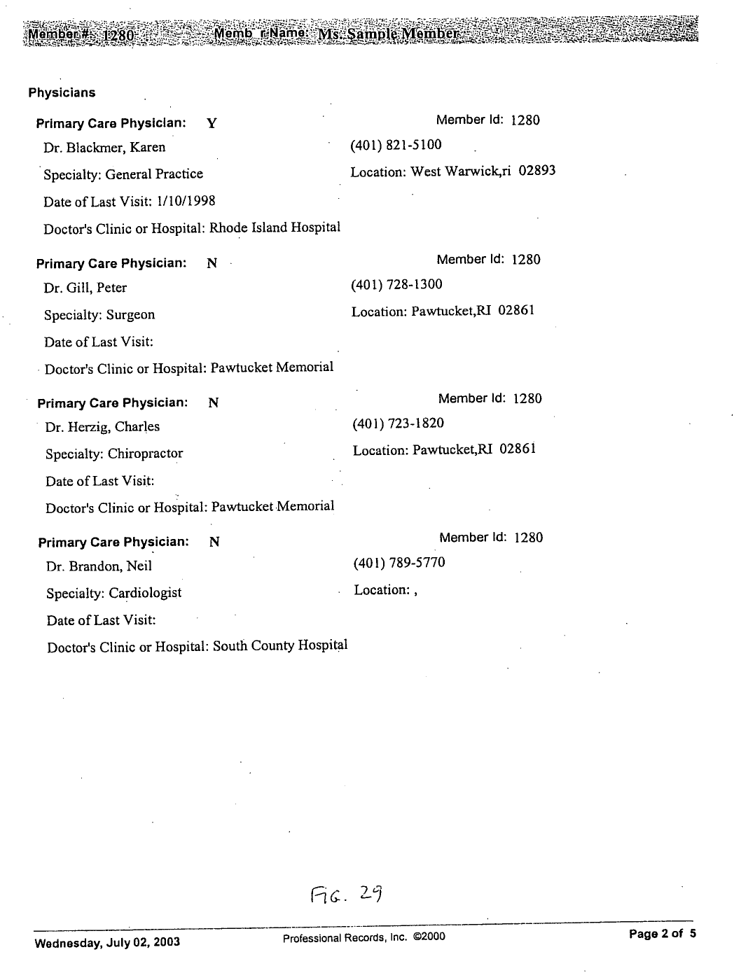

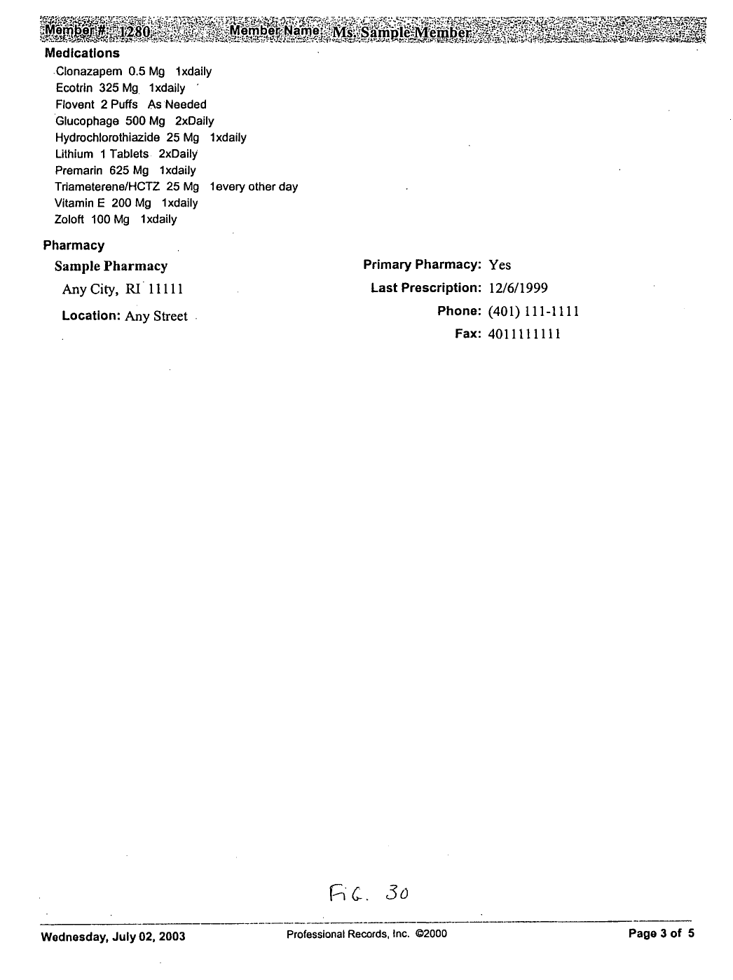

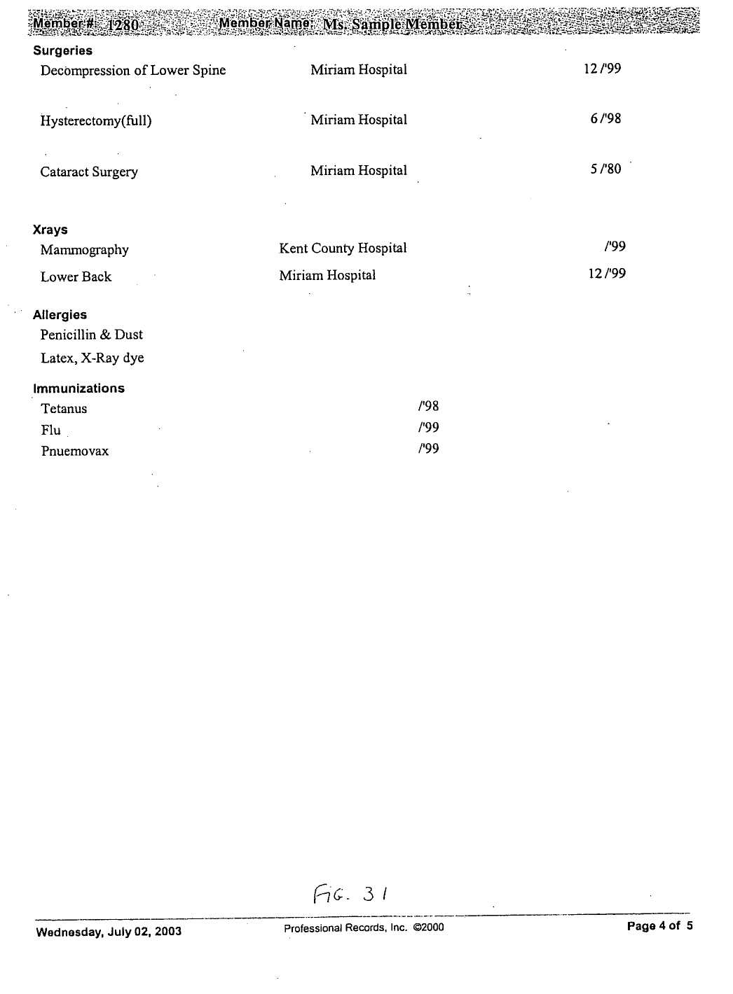

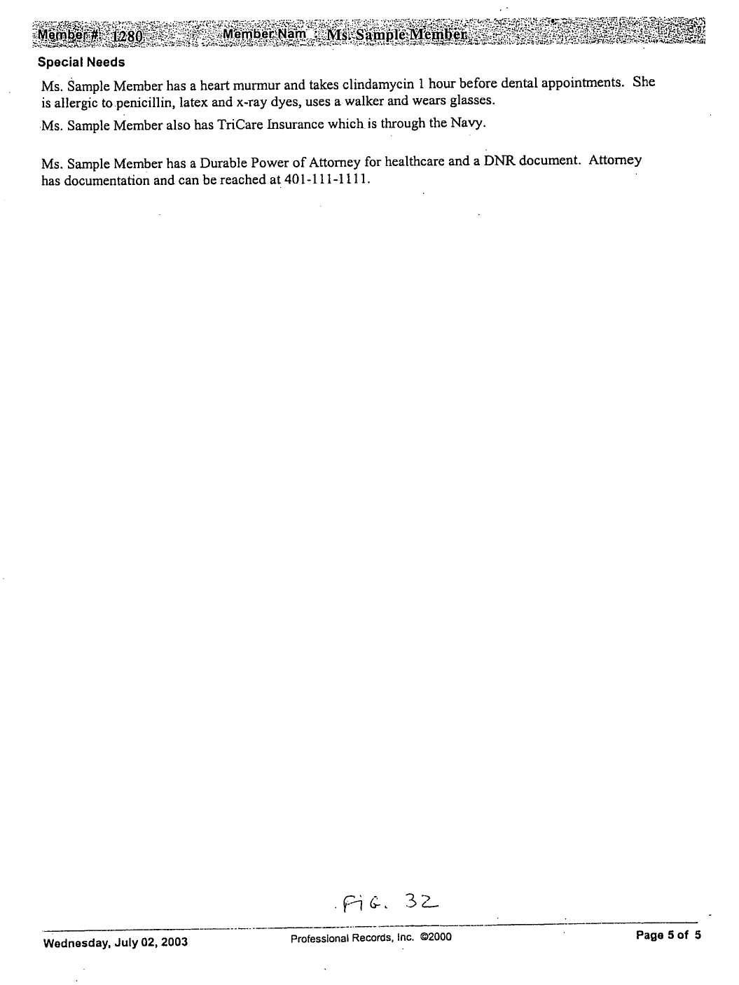

An exemplary embodiment of the present invention includes the ability to create a folder containing a report of member data contained in the ERC database for member, or patient, reference. FIGS. 28 through 32 depict sample pages that could be included in a medical data report to be included in a folder for home reference. The report can be tailored and include all or a subset of the medical data stored on the database for the patient. FIG. 28 includes member data and emergency contact data; FIG. 29 includes physician data; FIG. 3 includes medication and pharmacy data; FIG. 31 contains data about surgeries, x-rays, allergies and immunizations; and FIG. 32 includes special needs information. The report may be tailored based on the specific requirements of each implementation. The data contained in the reports is stored in the database in tables, such as those depicted in FIGS. 5 and 6.

Additional exemplary embodiments of the present invention include: printing ERC member cards (see FIG. 3 for an example); creating window decals for home and car to inform EMTs, fire, and police of membership; an appointment reminder service; creating a flow sheet to monitor weight, blood pressure, and/or cholesterol; the ability to translate medical data to another language for members who are in need of medical care while traveling; an express enrollment via a quick phone call; and the ability to convert to ERC comprehensive from ERC emergency or vice versa. In an exemplary embodiment of the present invention, patient medical data may be entered into the database in a variety of manners including being manually entered by an administrator and being uploaded from existing computer records. In addition, patient medical data may be updated in a variety of manners including being updated in real time in response to a data source (e.g., a data field in another computer application) being updated, manually by an administrator and in a batch mode from another computer system in response to an update in a data source.

The present invention provides a method to control medical information and as a result, the ability to aid in reducing mistakes and controlling medical insurance costs. ERC may be utilized to make patient medical information immediately accessible for emergency and routine medical treatment. Members may include the elderly, people traveling for business, college students and families who are relocating. ERC emergency functions may be implemented to make it easy to sign up by only requiring critical emergency medical data and a consent form. ERC comprehensive functions can be utilized by the medical community for routine medical care to aid in understanding the full medical data related to a particular patient.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. An embodiment of the invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for providing medical information, the method comprising:
receiving medical data about a patient;
storing said medical data;
receiving a consent form associated with said patient, wherein said patient has consented to the release of said medical data to a medical employee in response to the occurrence of a medical situation involving said patient;
storing said consent form;
receiving notification from said medical employee that said medical situation has occurred;
receiving a request from said medical employee to access said medical data;
retrieving a subset of said medical data responsive to said request from said medical employee and to said receiving notification; and
transmitting said subset of said medical data to said medical employee.

2. The method of claim 1 wherein said medical data includes emergency medical information.

3. The method of claim 2 wherein said emergency medical information includes name, birth date, allergies, blood type, primary physician name, primary physician telephone number, emergency contact name, emergency contact telephone number and medications.

4. The method of claim 1 wherein said medical data includes comprehensive medical information.

5. The method of claim 4 wherein said comprehensive medical information includes name, birth date, allergies, blood type, primary physician name, primary physician telephone number, specialist physician name, specialist physician telephone number, previous surgeries, membership information, insurance information, emergency contact name, emergency contact telephone number, and medications.

6. The method of claim 1 wherein said medical data includes emergency medical information and comprehensive medical information.

7. The method of claim 1 wherein said medical situation includes emergency care.

8. The method of claim 1 wherein said medical situation includes routine medical care.

9. The method of claim 1 wherein said medical situation includes emergency care and routine medical care.

10. The method of claim 1 wherein said receiving notification is via a telephone, a computer or a facsimile machine.

11. The method of claim 1 wherein said receiving a request is via a telephone, a computer or a facsimile machine.

12. The method of claim 1 wherein said transmitting is via a telephone, a computer or a facsimile machine.

13. The method of claim 1 wherein said retrieving is performed by searching a database for said medical data using a membership identification as a search field.

14. The method of claim 1 wherein said retrieving is performed by searching a database for said medical data using a city name as a search field.

15. The method of claim 1 wherein said retrieving is performed by searching a database for said medical data using a partial city name as a search field.

16. The method of claim 1 wherein said retrieving is performed by searching a database for said medical data using a telephone number as a search field.

17. The method of claim 1 wherein said retrieving is performed by searching a database for said medical data using a partial telephone number as a search field.

18. The method of claim 1 wherein said retrieving is performed by searching a database for said medical data using a last name as a search field.

19. The method of claim 1 wherein said retrieving is performed by searching a database for said medical data using a partial last name as a search field.

20. The method of claim 1 further comprising:
receiving a request for a report from said patient, said report including all or a subset of said medical data;
retrieving said report responsive to said request for a report from said patient; and
transmitting said report to said patient in response to said retrieving said report.

21. The method of claim 1 further comprising:
receiving a verification of information form associated with said patient; and
storing said verification of information form.

22. A system for providing medical information, the system comprising:
a network;
a storage device in communication with said network;
a user system in communication with said network; and
a host system in communication with said network, said host system including application software to implement a method comprising:
receiving medical data about a patient via said network;
storing said medical data in a database located on said storage device;
receiving a consent form associated with said patient via said network, wherein said patient has consented to the release of said medical data to a medical employee in response to the occurrence of a medical situation involving said patient;
storing said consent form in said database;
receiving notification from said medical employee that said medical situation has occurred;
receiving a request from said medical employee to access said medical data;
retrieving a subset of said medical data responsive to said request from said medical employee and to said receiving notification; and
transmitting said subset of said medical data to said medical employee.

23. The system of claim 22 wherein said host system and said user system are located in different geographic locations.

24. The system of claim 22 wherein said host system and said storage device are located in different geographic locations.

25. The system of claim 22 wherein said network is the Internet.

26. A computer program product for providing medical information, the computer program product comprising:
a storage medium readable by a processing circuit and storing instructions for execution by the processing circuit for performing a method comprising:
receiving medical data about a patient;
storing said medical data;
receiving a consent form associated with said patient, wherein said patient has consented to the release of said medical data to a medical employee in response to the occurrence of a medical situation involving said patient;
storing said consent form;
receiving notification from said medical employee that said medical situation has occurred;
receiving a request from said medical employee to access said medical data;
retrieving a subset of said medical data responsive to said request from said medical employee and to said receiving notification; and
transmitting said subset of said medical data to said medical employee.
